(19) United States
(12) Patent Application Publication
(10) Pub. No.: US 2009/0212929 A1
(43) Pub. Date: Aug. 27, 2009

(54) Verifying Vehicle Authenticity

(76) Inventors: Tal Drory, Haifa (IL); Amir Geva, Yokneam (IL); Asaf Tzadok, Nesher (IL); Eugeniusz Walach, Haifa (IL)

Correspondence Address: IBM CORPORATION, T.J. WATSON RESEARCH CENTER, P.O. BOX 218, YORKTOWN HEIGHTS, NY, 10598, US

(21) Appl. No.: 12/037,946

(22) Filed: Feb. 27, 2008

(51) Int. Cl. B60R 25/10

(52) U.S. Cl. 340/426.1

(57) ABSTRACT

A method for verifying authenticity of a vehicle, including programming a device to sequentially change a device element to an altered device element according to a change device element algorithm, and attaching the device to the vehicle. The method also includes generating the altered device element, and verifying that the altered device element matches an expected device element generated by the algorithm.

### FIELD OF THE INVENTION

The present invention relates generally to verifying vehicle authenticity, and specifically to vehicle verification using optical images.

### BACKGROUND OF THE INVENTION

Many countries and cities today are either using or are exploring charging a toll for road usage or for entering cities in order to decrease traffic congestion. One of the main methods used to bill drivers for toll charges is by using cameras to capture images of the cars driving on the road and then using Optical Character Recognition (OCR) in order to identify a license plate of the car. Once the car is identified, a license database may be used to identify the owner of the car and a bill may be sent to charge the toll.

However, there is an increasing trend of license plate theft, for example by unscrewing the plate and attaching it to another car. Car “cloning” is a significant problem in London, England, where, in order to avoid paying the congestion charge (a toll for driving in inner London), a license plate is copied from another car of a similar model and age. An efficient solution for verifying the authenticity of a vehicle is therefore desirable. cl SUMMARY OF THE INVENTION

In an embodiment of the present invention, a method for verifying authenticity of a vehicle, includes:

programming a device to sequentially change a device element to an altered device element according to a change device element algorithm;

attaching the device to the vehicle;

generating the altered device element; and

verifying that the altered device element matches an expected device element generated by the algorithm.

In an alternative embodiment of the present invention, apparatus for verifying authenticity of the vehicle, includes:

a device which is programmed to sequentially change a device element to an altered device element according to a change device element algorithm, and which is configured to be attached to the vehicle; and

a processor which is configured to receive the altered device element and to verify that the altered device element matches an expected device element generated by the change device element algorithm.

In a further alternative embodiment of the present invention, a computer software product for verifying authenticity of a vehicle, the product including a computer-readable medium having computer program instructions recorded therein, which instructions, when read by a computer, cause the computer to:

sequentially change a device element of a device to an altered device element according to a change device element algorithm, wherein the device is configured to be attached to the vehicle;

generate the altered device element; and

verify that the altered device element matches an expected device element generated by the algorithm.

The present invention will be more fully understood from the following detailed description of the embodiments thereof, taken together with the drawings, in which:

### BRIEF DESCRIPTION OF THE DRAWINGS

FIG. 1 is a schematic, pictorial illustration of a vehicle authentication system, in accordance with an embodiment of the present invention;

FIG. 2 is a schematic, pictorial illustration of a vehicle authentication device, in accordance with an embodiment of the present invention;

FIG. 3 is a flow chart that schematically illustrates a change display algorithm, in accordance with an embodiment of the present invention;

FIG. 4 is a flow chart that schematically illustrates the operation of an alternative change display algorithm, in accordance with an embodiment of the present invention;

FIG. 5 is a flow chart that schematically illustrates a method for verification of vehicle authenticity, in accordance with an embodiment of the present invention;

FIG. 6 is a flow chart that schematically illustrates a method for verification of vehicle authenticity, in accordance with an alternative embodiment of the present invention;

FIG. 7 is a schematic, pictorial illustration of an alternative vehicle authentication system, in accordance with an embodiment of the present invention;

FIG. 8 is a schematic, pictorial illustration of an authentication device in the system of FIG. 7, in accordance with an embodiment of the present invention;

FIG. 9 is a flow chart that schematically illustrates the operation of the authentication device of FIG. 8, in accordance with an embodiment of the present invention;

FIG. 10 is a flow chart that schematically illustrates the operation of an expected value algorithm, in accordance with an embodiment of the present invention; and

FIG. 11 is a flow chart that schematically illustrates a method for verifying vehicle authenticity in the system of FIG. 7, in accordance with an embodiment of the present invention.

### DETAILED DESCRIPTION OF EMBODIMENTS

### Overview

In some embodiments of the present invention, a device that is configured to authenticate a vehicle is attached to the vehicle. The device generates a device element such as a display, in which case the device is attached so that the display is visible external to the vehicle. The display is programmed to sequentially change according to a change display algorithm, and in order to authenticate the vehicle, an imaging device such as a camera captures an image of the display. The captured image is compared with an expected image generated by the algorithm in order to verify the authenticity of the vehicle.

Typically, the device is acquired by a vehicle operator, for example by purchasing the device in a store or by having a vehicle seller install the device prior to vehicle sale. The device acquirer may select a numeric value to be used as a device seed value in the change display algorithm, and the device seed value may be stored, along with a timestamp, in a database. Typically, the device acquirer associates the device seed value and the timestamp with a vehicle license plate number. If the device is purchased, for example, the timestamp is typically a purchase timestamp. Associating the device with the vehicle license plate number enables vehicle authentication using both the vehicle license plate number and the device.

In embodiments of the present invention, the device produces a display of color, pattern, text, or a combination thereof. The display is programmed to change on a periodic basis in a sequential manner, using the change display algorithm. As an example of device operation, on a toll road a traffic camera images the vehicle license plate and the altered display shown by the device. An expected display is generated for the device, according to a license plate number determined from the license plate. If the expected display is verified to match the altered display imaged by the camera, then the vehicle has been authenticated for toll collection. If the expected display does not match the altered display an alert may be raised. In this case, the police may be requested to perform a manual check of the vehicle. It is not possible for the device to be successfully counterfeited as a duplicate device will fail to display a valid altered display without knowledge of the device seed value and the timestamp.

In an alternative embodiment, the device element generated by the device is a pseudo-random number, and the device changes the pseudo-random number sequentially, substantially as described above for the change of the display. A radio-frequency identification (RFID) system or a cellular-based vehicle tracking system RFID system is also attached to the vehicle, and is configured to transmit the generated pseudo-random number for comparison with an expected device element, i.e., an expected pseudo-random number, in order to authenticate the vehicle.

In some embodiments two systems, such as an RFID system or a cellular-based vehicle tracking system together with a device generating a display, may be used to identify the vehicle. The two systems may be used to provide redundancy and/or to provide a higher degree of security.

### System Description

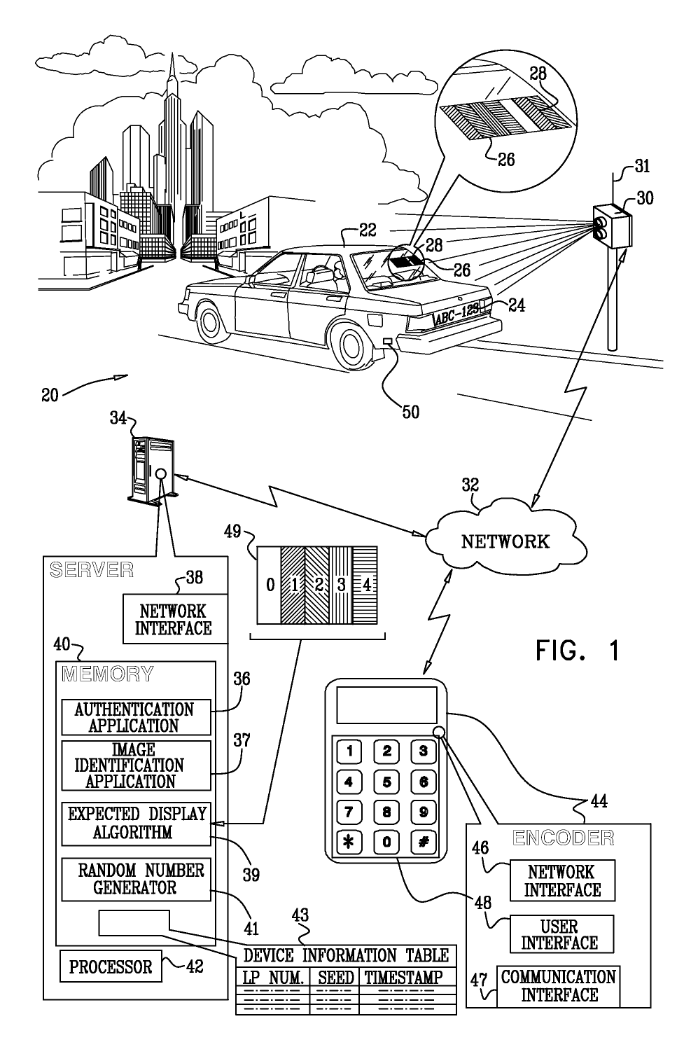

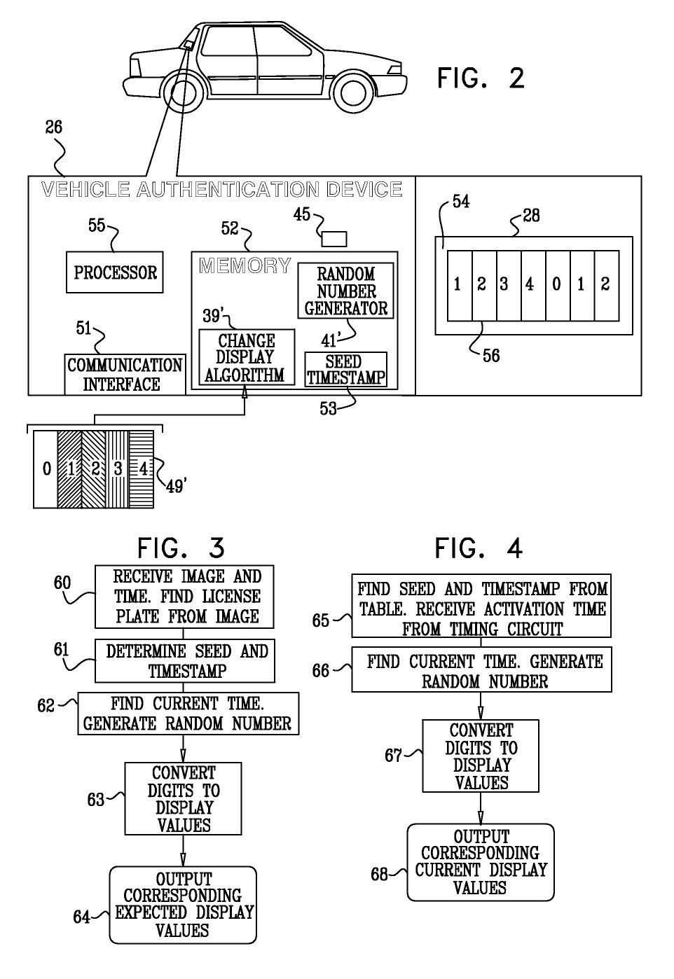

Reference is now made to FIG. 1, which is a schematic, pictorial illustration of a vehicle authentication system 20, in accordance with an embodiment of the present invention. In a disclosed embodiment of the present invention, a vehicle 22 has a license plate 24 and a vehicle authentication device 26. The vehicle authentication device has a display 28, which may display text, color, or pattern values, or any combination thereof. In operation of device 26, display 28 alters with time, and display 28 is also referred to herein as altered display 28 or current display 28. The vehicle authentication device is described below in reference to FIG. 2.

Typically, in system 20 there are a relatively large number of vehicles using respective vehicle authentication devices substantially similar to device 26.

A server 34 is able to receive an image of license plate 24, and is also able to receive an image of current display 28. The server can generate an expected display for authentication purposes. The server is herein assumed to comprise a network interface 38, a memory 40, and a processor 42. Memory 40 comprises an authentication application 36, an image identification application 37, an expected display algorithm 39, a pseudo-random number generator 41, and a device activation information lookup table 43, which are used by the processor as described below. In some embodiments memory 40 comprises a correspondence array 49 which translates between digits generated by generator 41, and the values of text, color and/or pattern shown on display 28.

An example of array 49 is shown in FIG. 1 as a correspondence between digits and colors, whereby the digit 0 corresponds to the color white, the digit 1 corresponds to the color black, the digit 2 corresponds to the color blue, the digit 3 corresponds to green, and the digit 4 corresponds to red, and where the colors are represented as different shadings. However, it will be understood that any other convenient correspondence array 49 between digits and text, color, or pattern displayed may be used.

Processor 42 typically comprises a general-purpose computer processor, which is programmed in software to carry out the functions that are described herein. The software may be downloaded to the processor in electronic form, over a network, for example. Alternatively or additionally, the software may be provided on tangible media, such as optical, magnetic, or electronic storage media. Further alternatively, at least some of the functions of the processor may be carried out by dedicated or programmable hardware.

Vehicle authentication device 26 may be obtained through a number of scenarios, including factory installation by the vehicle manufacturer, provision by an insurance company, or receipt as a gift. By way of example, hereinbelow the device is assumed to be obtained by purchase, and those having ordinary skill in the art will be able to adapt the explanation given herein, mutatis mutandis, to other scenarios for obtaining the device.

In embodiments of the present invention, an encoder 44 may be used when the vehicle authentication device is purchased to report device activation information, which is stored in table 43. The encoder may comprise a user interface 48, a communication interface 47, and a network interface 46. The encoder is connected to server 34 via network interface 46 by any means known in the art, for example, via a network 32 such as the Internet. Typically, at the time of purchase encoder 44 may be connected to device 26 via communication interface 47 by any means known in the art, for example, via a Universal Serial Bus (USB).

The device activation information comprises a license plate number of the vehicle for which the device is purchased, and typically a timestamp and/or a device seed value. In some embodiments, as described below, a timestamp may not be required. In some embodiments the device seed value may be provided to table 43 independently of the purchase of device 26, such as by a manufacturer of the device. Except as described below, herein it is assumed that the timestamp is used and is a purchase time, and that the device seed value is provided by the device buyer at the time of purchase.

Device Activation Information Table 43 thus stores a correspondence between the license plate number, the device seed number, and the timestamp of device 26. The table also stores equivalent sets of correspondences for the other devices, similar to device 26, operating in system 20.

User interface 48 comprises a numeric keypad or any mechanism known in the art which provides substantially the same functions as a numeric keypad. At purchase time, the device buyer chooses the device seed value, typically a number, and enters the device seed value into the encoder via the user interface. In some embodiments, the buyer enters the device seed value into the encoder without allowing a device seller to see the device seed value. For example, the device seed value may be entered in a similar fashion to keying in a personal identification number (PIN) when a debit card is used to make a purchase. The encoder sends the device activation information via network 32 to server 34, which stores the information, i.e., the license plate number, the device seed value, and the timestamp, in lookup table 43 in memory 40. The encoder also sends the timestamp and device seed value to device 26 via communication interface 47.

A camera 30, such as a traffic camera, is typically used to image altered display 28 and license plate 24 when vehicle 22 drives past the camera in a toll area. Camera 30 is connected to server 34 through the network in a manner similar to encoder 44. During operation of system 20, the camera sends the altered display and license plate images as well as an image capture time to server 34 via network 32.

Server 34 decodes the received images by using image identification application 37. Processor 42 executes the image identification application to decode the license plate number from the license plate image and to extract the altered display from the altered display image.

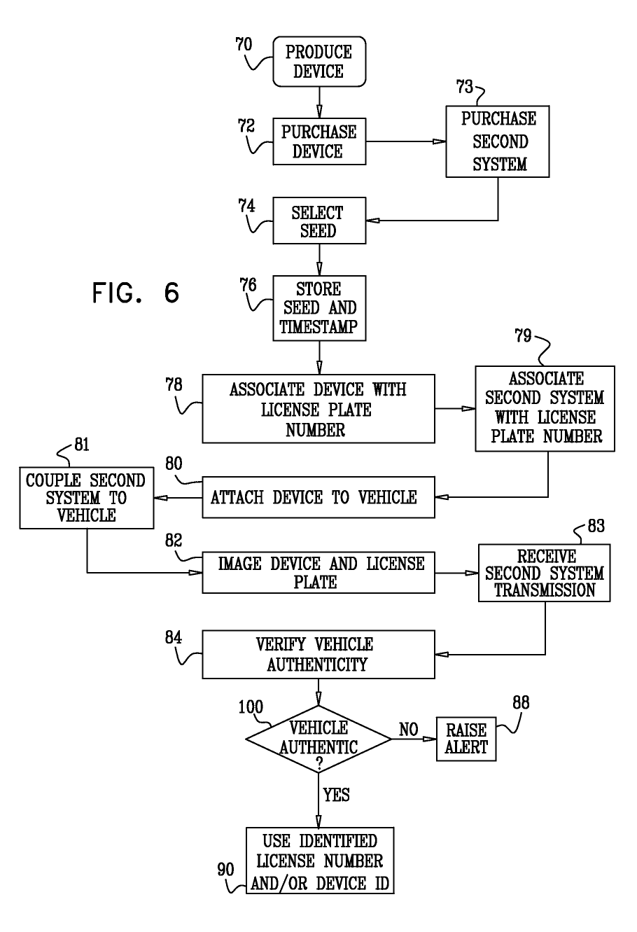

In some embodiments of the present invention, a second system 50 is coupled to the vehicle to supplement vehicle authentication device 26. An example of a second system is described hereinbelow in reference to FIG. 6.

As stated above, memory 40 comprises a pseudo-random number generator 41. After preset time intervals the generator provides pseudo-random numbers to expected display algorithm 39, and the algorithm uses the pseudo-random numbers to generate the expected displays. In the specification and in the claims, the term pseudo-random number is to be understood as a numerical value that is hard to predict or duplicate without prior knowledge of another value such as a seed and/or a timestamp, that can be predicted with such knowledge, and that is not a truly random number that cannot be predicted.

Pseudo-random number generator 41 generates a pseudo-random number RandomNumberT according to equation (1):

RandomNumberT=RG(S) (1)

where RG is a pseudo-random number generating function, and

S is a function seed value input into function RG.

Function seed value S is computed according to equation (2):

S=SG(DS,T) (2)

where SG is a seed generating function,

DS is the device seed value, and

T is a current time at which S is generated by function SG.

In a disclosed embodiment of the present invention, function RG is implemented using “rand”, as defined in the C programming language standard, which is available at the web site of the C standard group, open-std.org. Other suitable pseudo-random number generating functions may be selected, and will be apparent to those having ordinary skill in the art. Whichever function is chosen, it should output the same value, for a given input S, regardless of the type of server 34 upon which generator 41 is installed, and regardless of the processor operating in the server.

Function SG may be any convenient function of DS and T. Some examples for SG are:

SG(DS,T)=DS+T SG(DS,T)=RG(DS+T) SG(DS,T)=RG(RG(DS)+T) SG(DS,T)=RG(RG(DS)+RG(T)) (3)

Other suitable functions for SG will be apparent to those skilled in the art.

The value of T may be determined in a number of ways. For example, T may be an absolute time, so that T is substantially the same for all vehicles operating in system 20. Alternatively, T may be a relative time measured from a particular instant of time, such as the timestamp. In this case T is different for vehicles having different timestamps. T may be expressed in any convenient time unit such as minutes.

In the examples described below, except where otherwise stated it is assumed by way of example that T is a relative time measured relative to the timestamp.

From inspection of equations (1), (2), (3), it will be apparent that RandomNumberT may be generated with one execution of function RG, such as by using the first example of equations (3), or iteratively, using multiple executions of function RG, such as by using the other examples of equations (3). However, whichever type of equation (3) is used, given the value of DS and T, the value of RandomNumberT may be determined directly.

In some embodiments, the value of RandomNumberT from a previous value of T may be stored and may be used as a function seed value to iterate to a value of RandomNumberT for a current time T, by sequentially applying equation (1) for all preset time intervals from the previous value of T to the current time T. Hereinbelow, unless otherwise stated, the value of RandomNumberT is assumed to be determined directly, and those having ordinary skill in the art will be able to adapt the description herein, mutatis mutandis, for the sequential application of equation (1).

Reference is now made to FIG. 2, which is a schematic, pictorial illustration of vehicle authentication device 26, in accordance with an embodiment of the present invention. The device typically has a unique identifier, herein termed the device ID.

The vehicle authentication device comprises display 28, a processor 55, a communication interface 51, a change display algorithm 39′, and a pseudo-random number generator 41′ stored in a memory 52. Except as explained below, algorithm 39′, and generator 41′, are respectively generally similar in operation and properties to expected display algorithm 39 and pseudo-random number generator 41. As for generator 41, generator 41′ is deterministic, so that whether processor 42 or processor 55 inputs the device seed value DS and time T into its respective pseudo-random number generator, the pseudo-random number output is identical.

In embodiments having a correspondence array 49, a generally similar correspondence array 49′ is stored in memory 52. In some embodiments, display 28 comprises stripes 56 and a white frame 54 surrounding the stripes, where each stripe comprises an alphanumeric character, a color, or a pattern.

A device lookup table 53 stored in memory 52 comprises the device seed value DS and the timestamp that have been sent to device 26 from encoder 44, as described above.

The vehicle authentication device typically comprises an inexpensive electronic circuit 45 that tracks time, and which provides, as described below, an activation time T_{A} to generator 41′ at preset time intervals, such as every ten minutes.

Cameras such as camera 30 operating in system 20 may use white surrounding frame 54 to provide white balancing and/or to help locate the display in the image. Cameras typically adjust for color temperature by imaging a white colored object and setting a “white balance,” as is known in the art. White balancing may be necessary when camera 30 images vehicles moving from one lighting situation to another. The white surrounding frame also improves automatic location of the display in the image formed by the camera, and improves the success rate for automatic device recognition when the altered display is imaged.

By way of example, except where otherwise indicated, in the description hereinbelow display 28 is assumed to comprise seven stripes 56 and each stripe displays a numerical digit, as illustrated in FIG. 2.

Reference is now made to FIG. 3, which is a flow chart that schematically illustrates the operation of expected display algorithm 39 operating on server 34, in accordance with an embodiment of the present invention. Expected display algorithm 39 uses random generator 41, table 43, and identification application 37, to generate an expected display. In embodiments having correspondence array 49, algorithm 39 also uses the array.

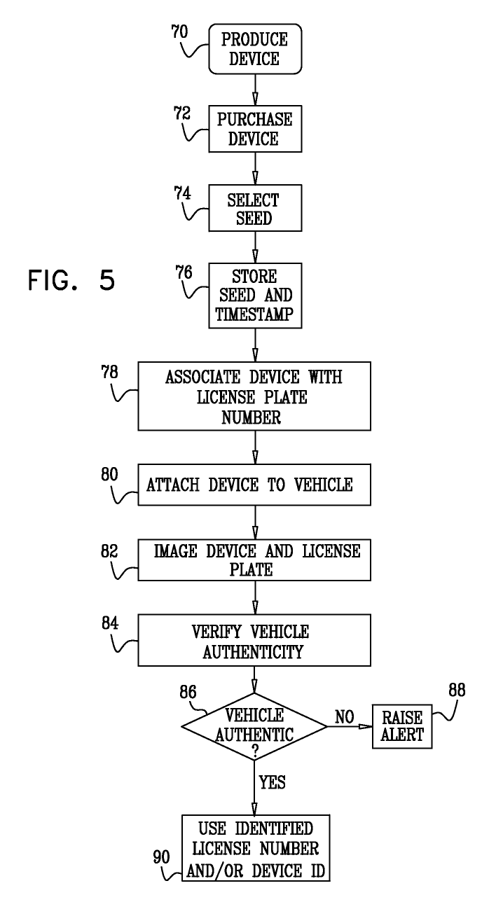

In an initial step 60, processor 42 receives an image from camera 30, and also an image capture time of the image. The processor applies identification application 37 to analyze the image so as to locate the license plate, and determines the license plate number from the license plate. (As described with respect to FIG. 5, the processor performs other analyses on the received image.)

In a second step 61, processor 42 accesses table 43, using the license plate number, to determine the device seed value DS and the timestamp associated with the license plate number.

In a pseudo-random number generating step 62, processor 42 determines a current time T as the difference between the image capture time and the timestamp. Using the device seed value DS, and time T, processor 42 executes generator 41 to determine a pseudo-random number, as described above with respect to equations (1), (2), and (3). As an example, the pseudo-random number produced is assumed to be “1234567.”

In an optional digit to display value converting step 63, processor 42 accesses array 49 to convert each digit in the pseudo-random number to a corresponding display value. For example, display 28 may use five colors, so that array 49 comprises a digit for each color. In this case processor 42 may calculate the modulo 5 value for each of the digits in the pseudo-random number, providing a result comprising seven digits, each ranging in value between 0 and 4. The result of the calculation for the pseudo-random number example of step 63 is 1234012.

In an expected display values outputting step 64, the pseudo-random number calculated in step 62, or the display values corresponding to the pseudo-random number calculated in step 63, and as determined from array 49, are output as the expected display.

FIG. 4 is a flow chart that schematically illustrates the operation of change display algorithm 39′ in device 26, in accordance with an embodiment of the present invention. Change display algorithm 39′ uses pseudo-random number generator 41′ and table 53 to generate current display 28. Optionally, algorithm 39′ may use correspondence array 49′

Change display algorithm 39′ uses steps 65, 66, 67, and 68, which, except for the differences described below, are respectively generally similar to steps 61, 62, 63, and 64 of FIG. 3. In contrast to algorithm 39, processor 55 executes algorithm 39′ at the preset time intervals received from circuit 45.

In a first step 65, processor 55 reads table 53 to determine the device seed value and the timestamp of device 26. In addition, processor 55 receives the value of an activation time T_{A} from circuit 45.

In a pseudo-random number generating step 66 processor 55 calculates a current time T as a difference between T_{A} and the timestamp. The processor executes generator 41′ using current time T and seed value DS.

Optional step 67 is substantially similar to optional step 63.

Step 68 is substantially similar to step 64, so that device 26 generates a current display 28 which is a function of the pseudo-random number generated in step 66.

Consideration of FIG. 3 and FIG. 4, and the associated explanations given above, demonstrate that change display algorithms 39 and 39′ are deterministic. For example, in the case of algorithm 39, an expected display can be generated at any point in time using the change display algorithm, given the stored device seed value DS, the timestamp, and a current time T corresponding to the interval between the timestamp and the activation time T_{A}.

Reference is now made to FIG. 5, which is a flow chart that schematically illustrates a method for verifying vehicle authenticity, in accordance with an embodiment of the present invention.

In a device producing step 70, pseudo-random number generator 41′ and change display algorithm 39′ are incorporated into vehicle authentication device 26 in memory 52, so that the device is able to display a sequence of display images using the generator and the algorithm, as described above with reference to FIG. 4. In disclosed embodiments of the present invention, display 28 may comprise color light-emitting diodes (LEDs), a liquid crystal array, simple mechanical color cards, or any suitable display mechanism known in the art.

In addition, in step 70 the preset time interval referred to above is programmed into the device, so that after each such preset time interval has elapsed, as determined by circuit 45, the circuit transmits an activation time T_{A} to processor 55, which executes generator 41′ to form a new random value, as described above with reference to FIG. 4. Also, the device ID is incorporated into the device.

In a device purchasing step 72, a vehicle operator purchases vehicle authentication device 26 from any suitable location, such as a store.

In a seed selecting step 74, the vehicle operator selects the device seed value DS and enters the device seed value into encoder 44 via user interface 48 (FIG. 1). The encoder typically calculates the timestamp to be the purchase time. Encoder 44 sends the device seed value and the timestamp to server 34 and to device 26.

In a seed and timestamp storing step 76, the server stores the device seed value and the timestamp in table 43. The device seed value and the timestamp are also stored in table 53 of device 26.

In a device and license plate number associating step 78, the vehicle operator associates his or her license plate number with the vehicle authentication device. The vehicle operator inputs the device ID and his or her license plate number to a device and license plate association application. The device and license plate number association application may be any application known in the art which accepts an input, in this case the device ID and the license plate number, and transmits the input over network 32, such as the Internet, to server 34. The device and license plate number association application is typically a secure web application. Thus, the license plate number and the device are associated on server 34 in table 43.

In an alternative embodiment, the device seed value and the timestamp are stored in table 43 and table 53 during device manufacture in device producing step 70. In the alternative embodiment, the timestamp may be a device creation time. In table 43 the timestamp and the device seed value may be temporarily associated with the device ID. After purchasing the device in device purchasing step 72, the vehicle operator may associate the license plate number with the device ID, generally as described hereinabove, so that the relationship of table 43, between the license plate number, the device seed value, and the timestamp, is formed.

In a device attaching step 80, the device is attached to vehicle 22. The device is typically placed inside the vehicle so as to be visible from outside the vehicle through the rear or the front window. Thus, after the device is attached, display 28 is visible external to the vehicle.

In a device and license plate imaging step 82, camera 30 images, i.e., captures an image of, vehicle 22, typically as the vehicle passes through a toll area. The camera sends the captured image of the vehicle and an image capture time to server 34 via network 32. Processor 42 identifies the altered display image and the license plate image in the captured image by executing image identification application 37 (FIG. 1). From the images, processor 42 uses application 37 to decode the license plate number and to extract the altered display.

In a vehicle authenticity verifying step 84, processor 42 uses the license plate number to find, from table 43, the device seed value DS and the timestamp associated with device 26. By finding the difference between the timestamp and the image capture time, processor 42 generates the value of T used by device 26 at the time camera 30 captured the image of the device.

As described above with reference to FIG. 3, using algorithm 39 and pseudo-random number generator 41 the processor applies the values of DS and T to generate a pseudo-random number, and from the pseudo-random number the expected display.

In a comparison step 86, the processor executes authentication application 36 to compare the expected display with the altered display in order to verify vehicle authenticity.

If in step 86 the vehicle authenticity has not been verified, because the two displays do not match, the vehicle may be assumed to have a cloned or stolen license plate or device. In an embodiment of the present invention, the police may be alerted to check the vehicle in an alert raising step 88.

If in step 86 the vehicle authenticity is verified, in a step 90 processor 42 may apply the license plate number of the vehicle and/or the device ID of device 26. The application is typically generating a billing for vehicle 22.

In addition, the current pseudo-random number and the image capture time may be stored, which is advantageous if the value of RandomNumberT is determined sequentially. In this case processor 42 replaces the device seed value and timestamp in table 43 with the current random value and the image capture time. Replacing these values saves processing time by eliminating the need for the processor to sequentially iterate through the pseudo-random number generator, to arrive at the time interval between the timestamp and the image capture time of subsequent license plate authentications.

Reference is now made to FIG. 6, which is a flow chart that schematically illustrates a method for verification of vehicle authenticity, in accordance with an alternative embodiment of the present invention. The method is generally similar to the method described in reference to FIG. 5, and, apart from the differences described below, steps indicated by the same reference numerals in the flow charts of FIG. 5 and FIG. 6 are generally similar in operation.

A second system 50 (FIG. 1) may be coupled to vehicle 22 to be used as a backup system to provide redundancy for vehicle authentication device 26. The second system may also be used to provide a higher degree of security. The second system typically comprises a radio-frequency identification (RFID) system or a cellular-based vehicle tracking system, or any other vehicle identification system known in the art. Hereinbelow, second system 50 is assumed to comprise an RFID system, and is also referred to as RFID tag 50.

In an embodiment of the present invention, the RFID tag is used to provide vehicle identification, typically by storing and remotely retrieving vehicle identification data. The RFID tag typically transmits a vehicle identifier, such as the license plate number, in response to an interrogating signal, so that the RFID tag acts as a transponder. The RFID tag typically has its own identification associated with it, herein termed the tag ID.

Steps 70 and 72 are substantially as described above with reference to FIG. 5. In a device purchasing step 73, a vehicle operator purchases the second system from a suitable location, such as a store. Steps 74, 76, and 78 are substantially as described above with reference to FIG. 5.

In a second system and license plate number associating step 79, the vehicle operator associates his or her license plate number with an RFID code of the second system in a manner that is generally similar to that described in reference to step 78. At the conclusion of step 79, the license plate number and the RFID code are associated on server 34 in table 43.

Step 80 is substantially similar to that of FIG. 5. In a second system and vehicle coupling step 81, the RFID tag is coupled to vehicle 22.

Step 82 is substantially as described above with reference to FIG. 5.

In a second system transmission step 83, radio waves transmitted by the RFID tag are received by an antenna 31 typically located near camera 30 (FIG. 1), although the antenna may be located in any other suitable location. The radio waves are typically generated in response to an interrogating signal received by the tag from the antenna. The radio waves comprise the RFID code, which is sent to server 34 via network 32 by any suitable method known in the art.

Vehicle authenticity verifying step 84 is substantially as described above for FIG. 5.

In a vehicle authenticity comparison step 100, the process described above in reference to step 86 is supplemented by an additional comparison. When processor 42 executes image authentication application 36, the image authentication application also compares the license plate number received from the receiving antenna with the license plate number identified from the captured vehicle image. If both license plate numbers match, the authentication application has verified the authenticity of the vehicle. If the license plate numbers do not match, the vehicle has not been verified as authentic and is suspect.

Steps 88 and 90 are substantially as described above in reference to FIG. 5.

Using the second system to identify the vehicle provides a higher degree of reliability that the vehicle is authentic, and typically helps to eliminate a false alert being raised when the license plate number is incorrectly identified by the image identification application.

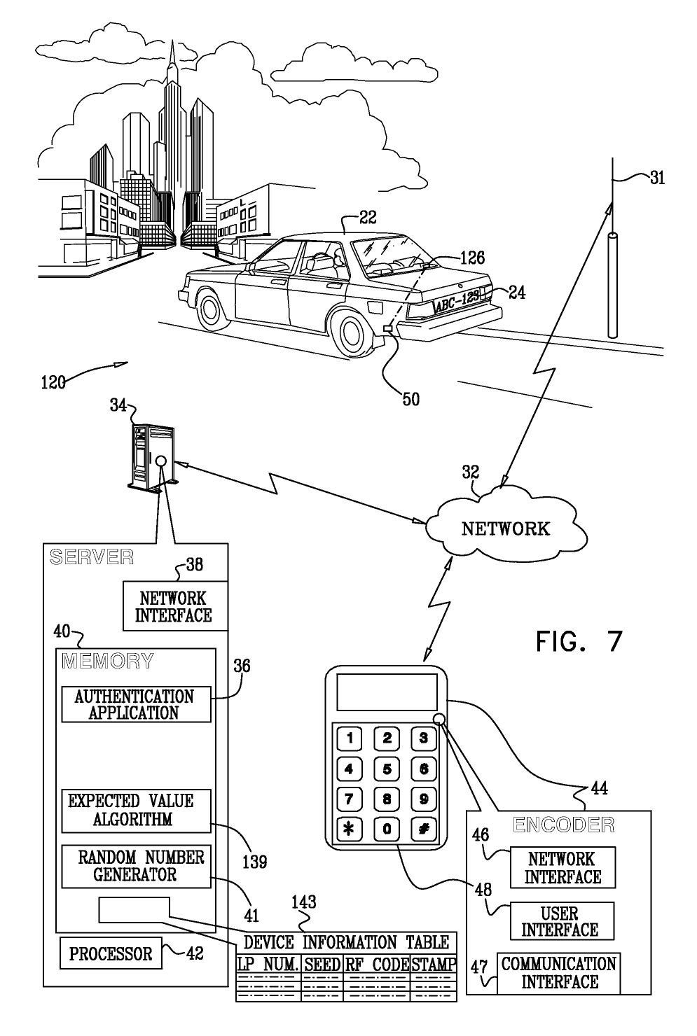

Consideration of the flow chart of FIG. 6 demonstrates that three separate elements are analyzed to authenticate vehicle 22, the license plate number, the display of device 26, and the RFID tag. In order for the vehicle to be considered authentic, the three elements correspond to the same vehicle. Returning to the flow chart of FIG. 5, two elements are analyzed, the license plate number and the display of device 26, and the two elements correspond to the same vehicle for authentication. Embodiments of the present invention comprise other combinations of elements that are analyzed, and that are checked for correspondence, in order to authenticate a vehicle. An example of an alternative system is described below with reference to FIGS. 7-11.

FIG. 7 is a schematic, pictorial illustration of a vehicle authentication system 120, in accordance with an alternative embodiment of the present invention. Apart from the differences described below, the operation of system 120 is generally similar to that of system 20 (FIG. 1), and elements indicated by the same reference numerals in both systems 20 and 120 are generally similar in construction and in operation.

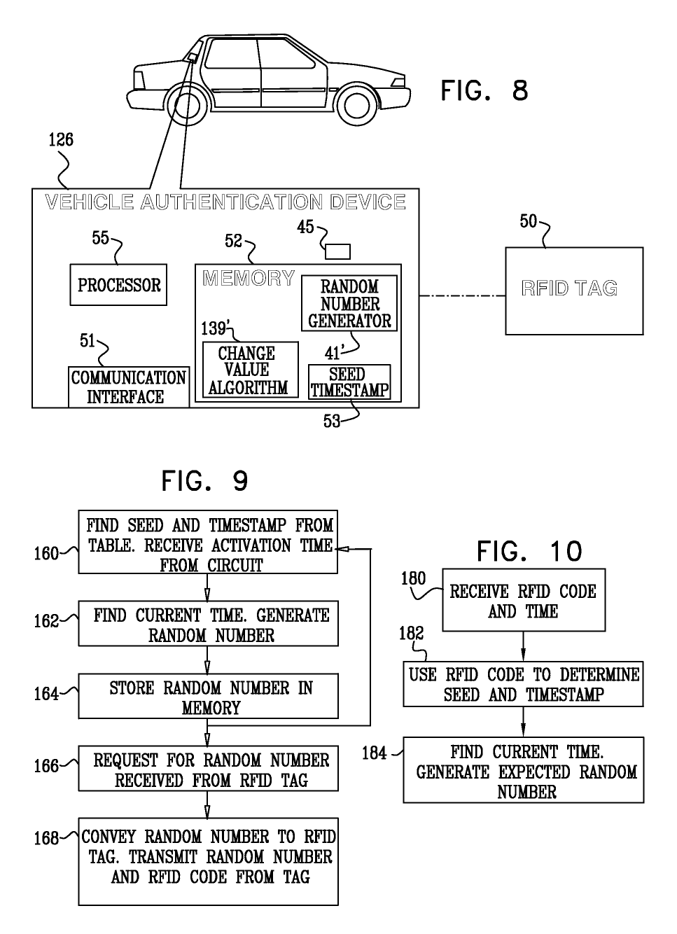

In system 120 there is no requirement for camera 30, and in place of device 26 an authentication device 126 is attached to vehicle 22. Device 126 is electrically coupled to RFID tag 50, as indicated by the broken line in FIG. 7. The structure and operation of authentication device 126 is described in more detail below with reference to FIG. 8 and FIG. 9.

In server 34 there is no image identification application 37 or array 49, and expected display algorithm 39 is replaced by an expected value algorithm 139. In addition, device information table 43 is replaced by a device information table 143. Table 143 comprises the correspondences of table 43, and in addition a respective RF code is associated with each set of license plate numbers, device seed values, and timestamps of table 43.

FIG. 8 is a schematic, pictorial illustration of authentication device 126, and FIG. 9 is a flow chart that schematically illustrates the operation of the device, in accordance with an embodiment of the present invention. Apart from the differences described below, the operation of device 126 is generally similar to that of device 26 (FIG. 2), and elements indicated by the same reference numerals in both devices 26 and 126 are generally similar in construction and in operation. As for device 26, device 126 is assumed to have a unique identifier, herein termed the device ID.

RFID tag 50 is attached to vehicle 22, and acts generally as described above for system 20, so that it transmits an RFID code to antenna 30 on receipt of an interrogation signal from the antenna. As stated above tag 50 is electrically coupled to device 126. Tag 50 is configured on receipt of the interrogation signal to convey a request to device 126 for a stored number, to receive the number from the device, and to transmit the number with the RFID code to antenna 30.

Unlike device 26, device 126 does not have a display. In addition, in place of change display algorithm 39′, device 126 comprises a change value algorithm 139′. As described below with reference to FIG. 9, device 126 operates generally as device 26, generating a pseudo-random number at the preset time intervals generated by circuit 45. (The intervals generated by circuit 45 are described above with reference to FIG. 2.)

FIG. 9 is a flow chart that schematically illustrates the operation of change value algorithm 139′. A first step 160 and a second step 162 are respectively substantially the same as steps 65 and 66 of the flow chart of FIG. 4. In a third step 164, processor 55 stores the generated pseudo-random number in memory 52. Processor 55 repeats steps 160, 162, and 164 iteratively, so that there is always a current pseudo-random number stored in memory 52.

In a fourth step 166, RFID tag 50 conveys a request for the stored current pseudo-random number to processor 55. The tag conveys the request in response to an interrogation signal received by the tag from antenna 30.

In a final step 168 device 126 conveys the stored current pseudo-random number to the tag, and the tag transmits the number and the RFID code to antenna 30 in response to the interrogation signal.

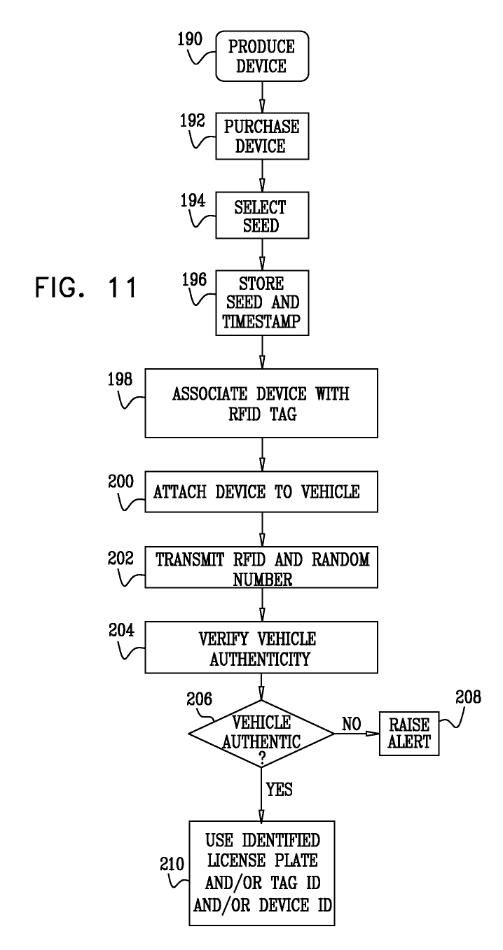

FIG. 10 is a flow chart that schematically illustrates the operation of expected value algorithm 139 in server 34, in accordance with an embodiment of the present invention. Processor 42 (FIG. 7) operates algorithm 139 when server 34 receives an RF code from antenna 31. As explained above, the RF code from tag 50 is transmitted to the antenna in response to an interrogation signal from the antenna.

In a first step 180, processor 42 receives the RFID code and the time at which the interrogation of the RFID tag was performed from antenna 31.

In a second step 182, processor 42 accesses table 143 to determine the device seed value DS and the timestamp corresponding to the received RFID code.

In a final step 184, processor 42 finds a current time T in response to a difference between the interrogation time and the timestamp. Inputting the value of T and DS to generator 41′, the processor generates an expected pseudo-random number.

FIG. 11 is a flow chart that schematically illustrates a method for verifying vehicle authenticity in system 120, in accordance with an embodiment of the present invention.

In a device producing step 190, pseudo-random number generator 41′ and change value algorithm 139′ are incorporated into vehicle authentication device 126 in memory 52. The preset time interval referred to above is programmed into the device, so that after each such preset time interval has elapsed, as determined by circuit 45, processor 55 executes generator 41′ to form a new current random value for storage in memory 52, as described above with reference to FIG. 9. In addition, device 126 is configured to communicate with RFID tag 50, and to provide the tag with the stored current random value on request from the tag. Also, the device ID is incorporated into the device.

Steps 192, 194, and 196 are respectively substantially as described for steps 72, 74, and 76 of FIG. 5, except that the operations described are performed for device 126, and the values stored in server 34 are stored in table 143. In some embodiments, in step 192 tag 50 may be purchased at the same time as device 126.

In an association step 198, the vehicle operator associates the device ID with RFID tag 50, typically using the tag ID. In addition, the operator typically associates the device and the tag with the license plate number of vehicle 22. The association may be performed substantially as described above for step 78 (FIG. 5). At the conclusion of step 198, the device seed value and timestamp are stored in table 53 of device 126, and the relationship of table 143, between the license plate number, the device seed value, the RFID code, and the timestamp, is formed.

In an attachment step 200, device 126 is attached to vehicle 22, so as to be in communication with RFID tag 50. In embodiments where the tag is purchased with device 126, the two components may be attached at substantially the same time, and typically in proximity to each other. The communication between the two components is typically by wireless signals, so that providing there is no electromagnetic barrier between them, and that the tag is able to transmit and receive electromagnetic signals external to the vehicle, the device and the tag may be positioned in any convenient location of the vehicle. Alternatively, the communication between the two components may be by any other method known in the art, such as by wire or fiber optic.

In a transmission step 202, tag 50 receives an interrogation signal from antenna 31, and the tag transmits the RFID code and the current pseudo-random number, as described above in steps 166 and 168 (FIG. 9). Antenna 31 then transmits the RFID code, the current pseudo-random number, and the interrogation time to server 34.

In a verification step 204, processor 42 in server 34 executes expected value algorithm 139, as described above with reference to FIG. 10, to determine an expected pseudo-random number.

In a comparison step 206, processor 42 compares the expected pseudo-random number with the current pseudo-random number. If the two numbers match, processor 42 proceeds to a step 210, wherein the processor 42 may apply the license plate number of the vehicle and/or the tag ID and/or the device ID of device 126, generally as described above for step 90 (FIG. 5).

If in step 206 the numbers do not match, an alert may be raised in a step 208, generally as described above for step 86.

Consideration of the description above of systems 20 and 120 shows that embodiments of the present invention sequentially change a device element, such as a display or a pseudo-random number, according to a change device element algorithm, such as the change display and change value algorithms described above. The algorithm is performed in a device attached to a vehicle. To authenticate the vehicle, a computer such as server 34 determines an expected device element, such as an expected display or an expected pseudo-random number, and verifies that the two device elements match. It will be appreciated that in embodiments of the present invention device elements other than those exemplified above may be used. For example, the device element may comprise a sonic or ultrasonic signal, or a combination of device elements exemplified herein.

It will be appreciated that although the descriptions above may derive a current time as a relative time using a timestamp, embodiments of the present invention may use an absolute time, in which case no timestamp may be needed to find the current time T required for the pseudo-random number algorithms described above. It will also be appreciated that while the pseudo-random number algorithms may have been assumed to operate directly, such algorithms may be operated sequentially, storing an intermediate pseudo-random number and iterating until the pseudo-random number for the current time T is determined.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for verifying authenticity of a vehicle, comprising:
programming a device to sequentially change a device element to an altered device element according to a change device element algorithm;
attaching the device to the vehicle;
generating the altered device element; and
verifying that the altered device element matches an expected device element generated by the algorithm.

2. The method according to claim 1, wherein the device element comprises a display, wherein the altered device element comprises an altered display, wherein the change device element algorithm comprises a change display algorithm, wherein attaching the device to the vehicle comprises attaching the device so that the display is visible external to the vehicle, wherein generating the altered device element comprises imaging an altered display, and wherein verifying that the altered device element matches the expected device element comprises verifying that the altered display matches an expected display generated by the change display algorithm.

3. The method according to claim 2, and comprising associating the device with a license plate number of the vehicle, and imaging a license plate of the vehicle so as to determine the license plate number.

4. The method according to claim 3, and comprising verifying that an identity of the vehicle agrees with the identity determined by the license plate number.

5. The method according to claim 2, and comprising coupling to the vehicle an alternative device configured to verify the authenticity of the vehicle, and verifying the authenticity of the vehicle by verifying the authenticity with the device and the alternative device.

6. The method according to claim 1, wherein programming the device comprises inputting at least one of a seed value and a timestamp to the change device element algorithm.

7. The method according to claim 1, and comprising providing a pseudo-random number generator that calculates a pseudo-random number and wherein the change device element algorithm changes the device element according to the pseudo-random number.

8. The method according to claim 7, wherein calculating the pseudo-random number comprises inputting a previous random value generated by the pseudo-random number generator to the pseudo-random number generator.

9. The method according to claim 1, wherein the device comprises a first processor configured to execute the change device element algorithm so as to generate the altered device element, and comprising providing a second processor configured to generate the expected device element according to the change device element algorithm, and to verify that the altered device element matches the expected device element.

10. The method according to claim 9, wherein the device element comprises a display, wherein attaching the device to the vehicle comprises attaching the device so that the display is visible external to the vehicle, wherein generating the altered device element comprises imaging an altered display, wherein verifying that the altered device element matches the expected device element comprises verifying that the altered display matches an expected display generated by the algorithm, and wherein imaging the altered display comprises determining an image capture time and conveying the image capture time to the second processor, and wherein generating the expected display comprises generating the expected display in response to the image capture time.

11. The method according to claim 1, wherein the device element comprises a pseudo-random number, wherein the altered device element comprises an altered pseudo-random number, wherein the change device element algorithm comprises a pseudo-random number generator, and wherein the expected device element comprises an expected pseudo-random number generated by the pseudo-random number generator.

12. The method according to claim 11, and comprising configuring the device to transmit the altered pseudo-random number via a transponder in response to an interrogation signal sent to the transponder.

13. The method according to claim 12, and wherein verifying that the altered pseudo-random number matches the expected pseudo-random number comprises determining the expected pseudo-random number in response to receiving an identity of the transponder.

14. A computer software product for verifying authenticity of a vehicle, the product comprising a computer-readable medium having computer program instructions recorded therein, which instructions, when read by a computer, cause the computer to:
sequentially change a device element of a device to an altered device element according to a change device element algorithm, wherein the device is configured to be attached to the vehicle;
generate the altered device element; and
verify that the altered device element matches an expected device element generated by the algorithm.

15. Apparatus for verifying authenticity of a vehicle, comprising:
a device which is programmed to sequentially change a device element to an altered device element according to a change device element algorithm, and which is configured to be attached to the vehicle; and
a processor which is configured to receive the altered device element and to verify that the altered device element matches an expected device element generated by the change device element algorithm.

16. The apparatus according to claim 15, wherein the device element comprises a display, wherein the altered device element comprises an altered display, wherein the change device element algorithm comprises a change display algorithm, wherein attaching the device to the vehicle comprises attaching the device so that the display is visible external to the vehicle, wherein generating the altered device element comprises imaging an altered display, and wherein verifying that the altered device element matches the expected device element comprises verifying that the altered display matches an expected display generated by the change display algorithm.

17. The apparatus according to claim 16, wherein the device is configured to be associated with a license plate number of the vehicle, and wherein the processor is configured to receive an image of a license plate of the vehicle so as to determine the license plate number.

18. The apparatus according to claim 16, wherein the device comprises a device processor configured to execute the change display algorithm so as to generate the altered display, and wherein the processor comprises a server processor configured to generate the expected display according to the change display algorithm, and to verify that the altered display matches the expected display.

19. The apparatus according to claim 15, wherein the device element comprises a pseudo-random number, wherein the altered device element comprises an altered pseudo-random number, wherein the change device element algorithm comprises a pseudo-random number generator, and wherein the expected device element comprises an expected pseudo-random number generated by the pseudo-random number generator.

20. The apparatus according to claim 19, and comprising configuring the device to transmit the altered pseudo-random number via a transponder in response to an interrogation signal sent to the transponder, and wherein verifying that the altered pseudo-random number matches the expected pseudo-random number comprises determining the expected pseudo-random number in response to receiving an identity of the transponder.
